(19) United States
(12) Patent Application Publication
(10) Pub. No.: US 2013/0063423 A1
(43) Pub. Date: Mar. 14, 2013

(54) USER INTERFACE OF AN ELECTRONIC DEVICE

(71) Applicants: Che-Hao Hsu, Taipei City (TW); Fu-Tsung Yang, Taipei City (TW); Kai-Lung Hua, Taipei City (TW)

(72) Inventors: Che-Hao Hsu, Taipei City (TW); Fu-Tsung Yang, Taipei City (TW); Kai-Lung Hua, Taipei City (TW)

(73) Assignee: National Taiwan University of Science and Technology, Taipei City (TW)

(21) Appl. No.: 13/535,883

(22) Filed: Jun. 28, 2012

(30) Foreign Application Priority Data
Sep. 9, 2011 (TW) 100132597

(51) Int. Cl. G06T 15/00

(52) U.S. Cl. 345/419

(57) ABSTRACT

The present invention discloses a unique user interface of an electronic device. The user interface comprises a first interface and a second interface. The said first interface has a displaying mode and an operating mode. The displaying mode is capable of automatically and continuously displaying a first polyhedron icon by rotating thereto in a certain sequence. The operating mode is capable of rotating the polyhedron icon in accordance with the order of the user. The second interface is capable of displaying the polyhedron by unfolding it so as to display the displaying surfaces thereof. Furthermore, the present invention has an output mode. in the output mode, a plurality of reserved intervals are added on the periphery of the development drawing of polyhedron icon so as to provide a non-digital, physical 3D polyhedron by cutting, adhering and folding the reserved intervals.

### BACKGROUND OF THE INVENTION

1. Field of the Invention

The present invention relates to a user interface of an electronic device, and more particularly, the user interface comprises a plurality of polyhedron icons for browsing the images.

2. Description of the Prior Art

With the development of touch panel, the electronic devices are easy to manipulate straightly with fingers. In conjunction with a user interface, the images or the presentations on a display screen can be moved, rotated, or scaled at any time. Though the touch display system can be used conveniently, the operation is limited to the size of fingers. Therefore, it is necessary to display with bigger ICON. However, the operation is also limited to the size of screen, and all the operating functions can not display at the same time. So that is why we need to change the display mode for displaying more.

Furthermore, intelligent mobile phones, tablet personal computers, and various mobile devices are applied to take photos and read documents. With the increase of such applications, how to browsing and categorizing a great number of data more efficiently is a primary concern. There are many different display interfaces for improving this problem, such that the preview images are used for improving the display of images and allow users to easily use these images, but these display interfaces still have a common drawback. The preview images are too small to appear clearly. fin other words, it is still hard to improve the problems of the prior art.

### SUMMARY OF THE INVENTION

Therefore, a scope of the invention is to provide a user interface of an electronic device, and more particularly, the user interface comprises a plurality of polyhedron icons for browsing the images.

A user interface of an electronic device of the invention comprises a first interface. The first interface comprises a first region and a second region, wherein the first region further comprises a first polyhedron icon, and the second region further comprises a second polyhedron icons and a plurality of third polyhedron icons. Each of the first, second, and third polyhedron icons comprises two or more display surfaces, and these display surfaces are applied to present a corresponding image respectively.

In practice, the images of the display surfaces on the first polyhedron icon and the images of the display surfaces on the second polyhedron icon are the same; and, the images of the display surfaces on the first polyhedron icon and the images of the display surfaces on the third polyhedrons icon are all different. Additionally, the images of each display surface on the first polyhedron icon and the images of each display surface on the polyhedron icons configured on the second region are all different. That is to say these images on the first polyhedron icon and those images on the second polyhedron icon are not restricted to be similar.

Otherwise, the second polyhedron icon is configured on the perpendicular bisector of the first interface, and the area occupied by the second polyhedron icon is greater than the area occupied by the third polyhedron icons. At the same time, the area occupied by the first polyhedron icon is greater than the area occupied by the second polyhedron icon. Moreover, the first region is adjacent to the second region out any overlap. Wherein, the polyhedron icons on the second region are adjacent to each other without any overlap. To be noticed, the sizes and the positions of the first polyhedron icon, the second polyhedron icon, and the third polyhedron icons can be adjusted according to the settings of a user.

Additionally, the first interface of the present invention further comprises a fourth region for displaying a working envelope, and the content of the working envelope corresponds to the content of the display surface which has the largest area on the first polyhedron icon, wherein the fourth region is adjacent to the first region and the second region without any overlap.

Another scope of the invention further discloses a user interface of an electronic device. The user interface of the electronic device comprises an output mode for displaying a development drawing of a polyhedron icon, and the polyhedron icon having a plurality of display surfaces for presenting a corresponding image respectively. Moreover, the periphery of the development drawing having a plurality of reserved intervals, and wherein the development drawing can be turned into a three-dimensional polyhedron icon by adhering and folding the reserved intervals after printed.

To sum up, the present invention discloses a unique user interface of an electronic device. The present invention uses many original images to form a plurality of polyhedron icons. Moreover, the user interface comprises a first interface and a second interface. The said first interface has a displaying mode and an operating mode. The displaying mode is capable of automatically and continuously displaying a first polyhedron icon by rotating thereto in a certain sequence. The operating mode is capable of rotating the polyhedron icon in accordance with the order of the user. The second interface is capable of displaying the polyhedron by unfolding it so as to display the displaying surfaces thereof. Furthermore, the present invention has an output mode. In the output mode, a plurality of reserved intervals are added on the periphery of the development drawing of polyhedron icon so as to provide a non-digital, physical 3D polyhedron by cutting, adhering and folding the reserved intervals. Additionally, the invention provides a switching speed of the display surfaces which is one to three times faster than conventional ones, and the invention also comprises a function of correcting the image orientation. Therefore, the present invention can improve the problems of the prior art.

Many other advantages and features of the present invention will be further understood by the detailed description and the accompanying sheet of drawings.

### BRIEF DESCRIPTION OF THE APPENDED DRAWINGS

FIG. 1 is a schematic diagram illustrating an electronic device according to one embodiment of the present invention.

FIG. 2A is a schematic diagram illustrating a first interface of the user interface according to an embodiment of the present invention.

FIG. 2B is a schematic diagram illustrating a second interface of the user interface according to an embodiment of the present invention.

FIG. 2C is a schematic diagram illustrating a third interface of the user interface according to an embodiment of the present invention.

FIG. 3 is a schematic diagram illustrating a first interface of the user interface according to another embodiment of the present invention.

FIG. 4A is a schematic diagram illustrating a first interface of the user interface as the presentation on the display surface is a photo according to another embodiment of the present invention.

FIG. 4B is a schematic diagram illustrating a first interface of the user interface as the presentation on display surface is an operation interface according to another embodiment of the present invention.

FIG. 5 is a schematic diagram illustrating a demonstration sequence of the first polyhedron icon according to another embodiment of the present invention.

FIG. 6 is a schematic diagram illustrating a second interface of the user interface according to another embodiment of the present invention.

FIG. 7 is a schematic diagram illustrating an output mode of the user interface according to another embodiment of the present invention.

FIG. 8A is a schematic diagram illustrating a sense of rotation of the first polyhedron icon according to another embodiment of the present invention.

FIG. 88 is a schematic diagram illustrating a sense of rotation of the first polyhedron icon according to another embodiment of the present invention.

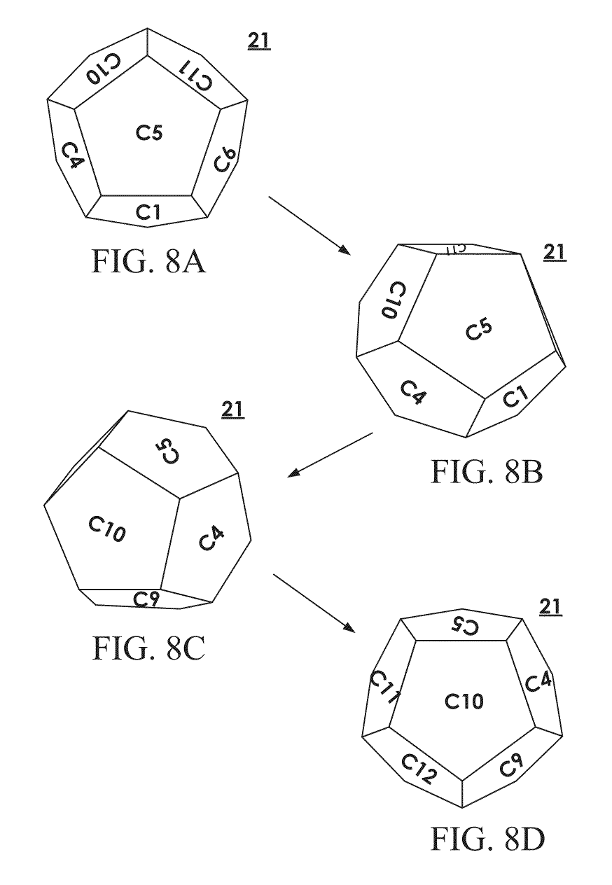

FIG. 8C is a schematic diagram illustrating a sense of rotation of the first polyhedron icon according to another embodiment of the present invention.

FIG. 8D is a schematic diagram illustrating a sense of rotation of the first polyhedron icon according to another embodiment of the present invention.

To facilitate understanding, identical reference numerals have been used, where possible to designate identical elements that are common to the figures.

### DETAILED DESCRIPTION OF THE INVENTION

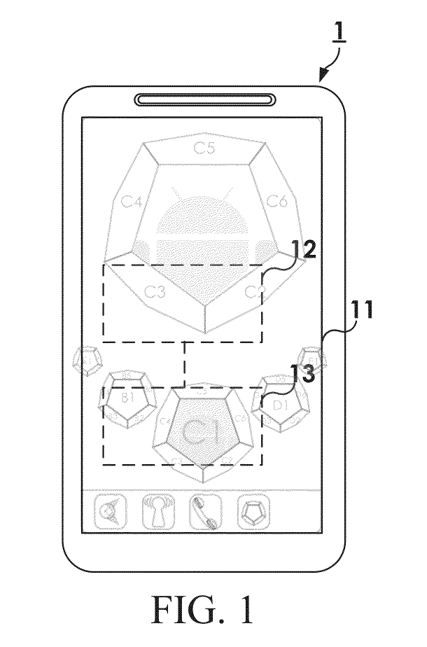

The invention discloses a user interface of an electronic device, and more particularly, the user interface comprises a plurality of polyhedron icons for browsing the images. Please refer to FIG. 1. FIG. 1 is a schematic diagram illustrating an electronic device according to one embodiment of the present invention. As shown in FIG. 1, an electronic device 1 comprises a display module 11, a memory module 12, and a processing module 13. In practice, the processing module 13 of the electronic device 1 can read the data of user interface from the memory module 12 and then proceed to operate. After that, a first interface S1, a second interface S2, and a third interface S3 can be displayed on the display module 11 according to the settings of users.

In the embodiment, the electronic device 1 is an intelligent mobile phone, and the electronic device 1 can represent the systems comprising the display module 11, the memory module 12, and the processing module 13 simultaneously, such as: digital camera, portable computer, and/or tablet personal computers. To be noticed, the present invention is not limited to be an embedded system. With the cloud engineering, the memory module 12 and the processing module 13 can be configured on internet respectively without any physical connection.

The display module 11 generally refers to the video display element. In the embodiment, the display module 11 can be, but is not limited to being, a display panel, a projector, and/or other display units. Furthermore, the display module 11 can be used to operate the electronic device 1 by the input devices.

In the embodiment, the memory module 12 generally refers to the information storage apparatus, and more particularly, the memory module 12 can be, but is not limited to being, a memory device, a hard disk, and/or a USB drive.

The processing module 13 refers to the data processing components, and more particularly, the processing module 13 can be a central processing unit, other hardware or software which has the data processing function. Otherwise, the processing module 13 has an electrical connection with the display module 11 and the memory module 12. Wherein, there is a build-in graphics engine which can support the 3D graphics library, such as OpenGL or Direct X, in the processing module 13 of the invention. After reading the data of user interface from the memory module 12, the processing module 13 proceeds to operate and generate a first interface S1, a second interface 32, and a third interface 33. To be noticed, the sizes and the positions of the first polyhedron icon, the second polyhedron icon, and the third polyhedron icons can be adjusted according to the settings of a user.

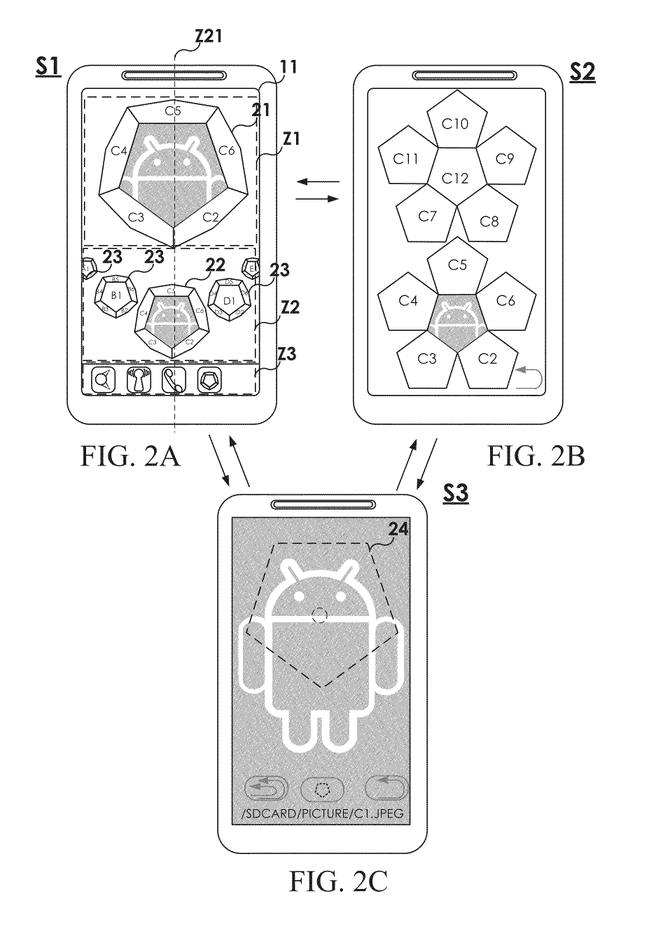

The user interface of the electronic device comprises a first interface S1, a second interface S2, and a third interface S3. Please refer to FIG. 2A, FIG. 2A is a schematic diagram illustrating a first interface of the user interface according to an embodiment of the present invention. As shown in FIG. 2A, there are a plurality of polyhedron icons 21, 22, 23 distributed among the first interface S1. Each polyhedron icon is a regular dodecahedron which has twelve display surfaces respectively, wherein each display surface is a regular pentagon. In the prior art, the regular hexahedron can display only three images. Compared with the regular hexahedron, the present invention can display six images at the same time, and the image on the central display surface is more lager, so that the user can observe the images more clearly. Additionally, when the regular dodecahedron is switched onto adjacent the display surfaces, the switch speed can be one to three times faster than the regular hexahedron or other polyhedron interfaces. Although the regular dodecahedron has a lot of advantages mentioned above, the polyhedron icons 21, 22, 23 can be, but is not limited to being, a regular dodecahedron, a regular tetrahedron, a regular hexahedron, a regular octahedron, and/or other regular polyhedrons.

Otherwise, each display surface on the polyhedron icon 21, 22, 23 displays mutually independent images. As shown in FIG. 2A, the images can be a picture, a character, and/or a symbol, wherein the picture is applied to present various icon such as: document icons, application icons, toolbar icons, and menu icons. In the embodiment, each display surface on the first polyhedron icon 21 displays photos and various text elements.

In the embodiment, the first interface S1 comprises a first region Z1, a second region Z2, and a third region Z3. Wherein, the definition of the first region Z1 can be a space around the edge of the first polyhedron icon 21, and the second region Z2 can be defined as a space around the edge of the other polyhedron icons 22, 23 except the first polyhedron icon 21. The first region Z1 and the second region Z2 are not limited to be the definition mentioned above. Moreover, the first region is adjacent to the second region without any overlap.

The third region Z3 further comprises a plurality of icons, and each icon has a function such as copy, share, delete, and/or other relative functions.

The second region Z2 comprises a second polyhedron icon 22 and a plurality of third polyhedron icons 23. In the embodiment, the polyhedron icon selected from the second region Z2 by a user can be enlarged and displayed on the first region Z1 for forming the first polyhedron icon 21, meanwhile, the selected polyhedron icon is retained on the second region Z2 as the second polyhedron icon 22. More particularly, the display images and the arrangement of display surfaces on the first polyhedron icon 21 are the same as the display images and the arrangement of the second polyhedron icon 22. Wherein, the area occupied by the first polyhedron 21 icon is greater than the area occupied by the second polyhedron icon 22. Therefore, users can preview the display images of the second polyhedron icon 22 clearly with the help of the first polyhedron icon 21.

Additionally, the perpendicular bisector Z21 of the first region Z1 across the second polyhedron icon 22, and the area of the second polyhedron icon 22 is greater than the area of third polyhedron icons 23 configured on the second region Z2. The second and third polyhedron icons 22, 23 on the second region Z2 are contiguous without overlap. Furthermore, the sizes and the positions of the first polyhedron icon 21, and the second and third polyhedron icons 22, 23 on the second region Z2 can be adjusted according to the settings of a user.

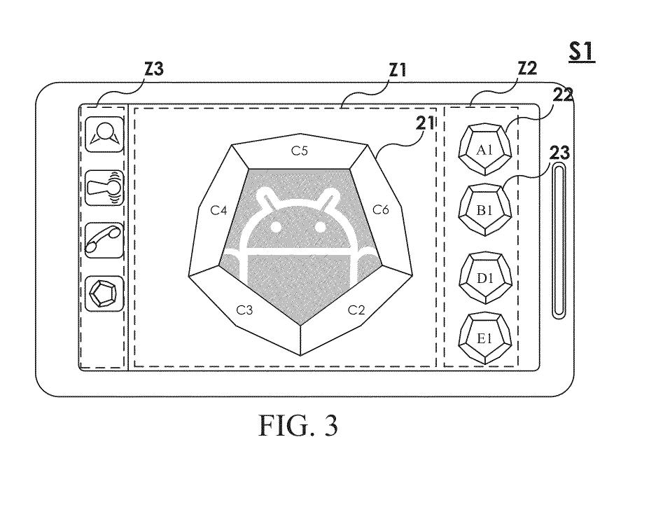

Please refer to FIG. 3. FIG. 3 is a schematic diagram illustrating a first interface of the user interface according to another embodiment of the present invention. As shown in FIG. 3, when a user selects a third polyhedron icon 23 from the second region Z2, the third polyhedron icon 23 which is selected can be removed from the second region Z2 to the first region Z1, and turns to be the first polyhedron icon 21. Subsequently, when the user selects another third polyhedron icon 23 from the second region Z2 again, the current first polyhedron icon 21 will be reduced back to original size on the second region Z2, and be replaced by the another third polyhedron icon 23. Therefore, the display images and the arrangement of display surfaces on the first polyhedron icon 21 are different with the display images and the arrangement of the second or third polyhedron icons 22, 23. In the embodiment, the areas of the second and third polyhedron icons 22, 23 on the second region Z2 are in essence the same.

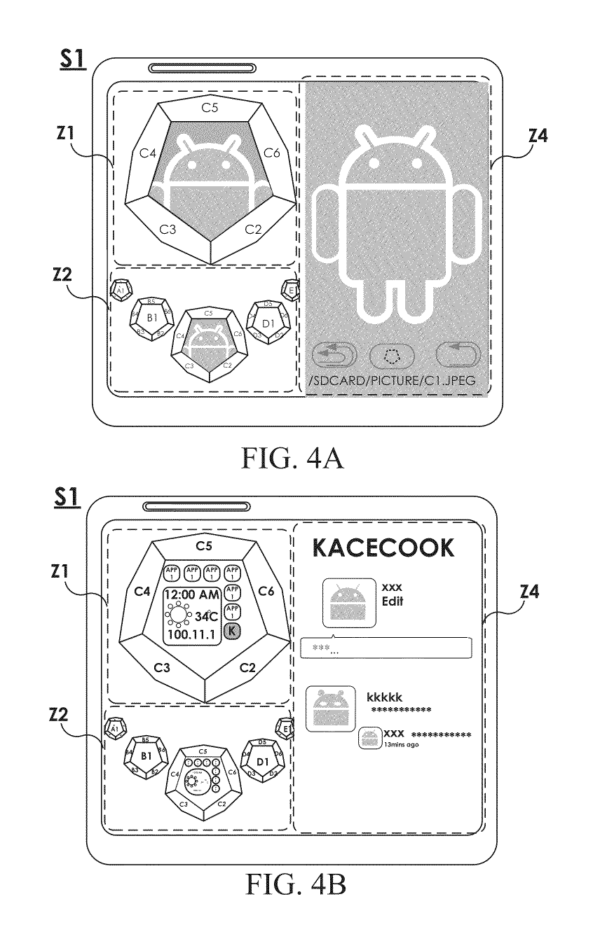

Please refer to FIG. 4A and FIG. 4B. FIG. 4A and FIG. 4B are the schematic diagrams illustrating a first interface of the user interface according to another embodiment of the present invention. The first interface S1 can further comprise a fourth region Z4 as the size of the display module 11 is large enough. The fourth region Z4 is adjacent to the first region Z1 and the second region Z2 without overlap.

The fourth region Z4 is applied to display a working envelope, and the content of the working envelope corresponds to the content of the display surface which has the largest area on the first polyhedron icon. As shown in FIG. 4A, when the presentation on the display surface is a photo, the photo can be displayed onto the working envelope with full-width. As shown in FIG. 4B, when the presentation on the display surface is an operation interface, the fourth region Z4 can display the corresponding presentation of the operation interface.

Please refer to FIG. 2A again, the first interface S1 has a displaying mode and an operating mode. The displaying mode is capable of automatically and continuously displaying a first polyhedron icon 21 by rotating thereto in a certain sequence.

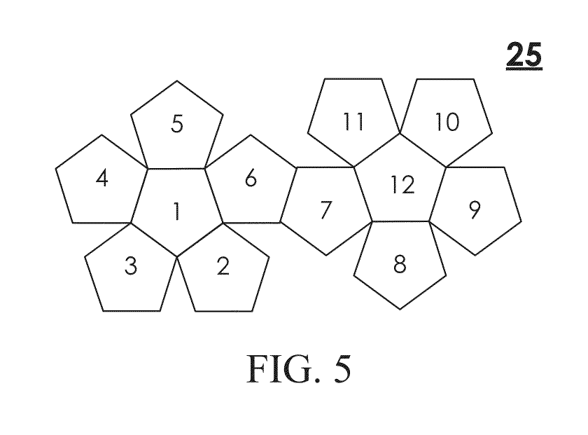

Please refer to FIG. 5. FIG. 5 is a schematic diagram illustrating a demonstration sequence of the first polyhedron icon according to another embodiment of the present invention. As shown in FIG. 5, the development drawing 25 presents the demonstration sequence of the first polyhedron icon 21 in the displaying mode. Please refer to FIG. 2A again, after twelve display surfaces of the first polyhedron icon 21 are displayed, the second polyhedron icons 22 on the second region Z2 slip toward left for making the third polyhedron icon 23 move to the center, so that, anew first polyhedron icon 21 can be formed. Therefore, when all the second and third polyhedron icons 22, 23 on the second region Z2 are displayed completely, these polyhedron icons can be continuously repeated in the demonstration sequence.

Moreover, the user interface can be turned into the operating mode when a triggering signal occurs in the displaying mode, such as touch and click. The operating mode is capable of rotating the polyhedron icon in accordance with the order of the user. In order to display every image properly without inversion, the sense of rotation is limited as the first polyhedron icon 21 is rotated axially.

In the embodiment, the tip apex of the first polyhedron icon 21 can only be upwards or downwards. However, the limiting function of the rotation direction can be shut down for free rotation in accordance with the order of the user. To be noticed, the user can adjust the parameter setting of the first polyhedron icon 21 such as: size, rotating speed, rotating angle, and sense of rotation. Wherein, the invention also comprises a function of correcting the image orientation. Take for example the sense of rotation, please refer to FIG. 8A to FIG. 8D in sequence. FIG. 8A to FIG. 8D are the schematic diagrams illustrating a sense of rotation of the first polyhedron icon according to another embodiment of the present invention respectively. When a user wants to rotate the first polyhedron icon 21 from the display surface C5 to the display surface C10 for browsing, the user interface can correct the image orientation automatically, so that the image can be displayed properly without inversion.

Additionally, users can input the corresponding orders to the electronic device 1 for browsing all the display surfaces of first polyhedron icon 21, so that the second interface S2 and the third interface S3 can be presented. To facilitate understanding, the second interface S2 and the third interface S3 are elaborated hereinafter.

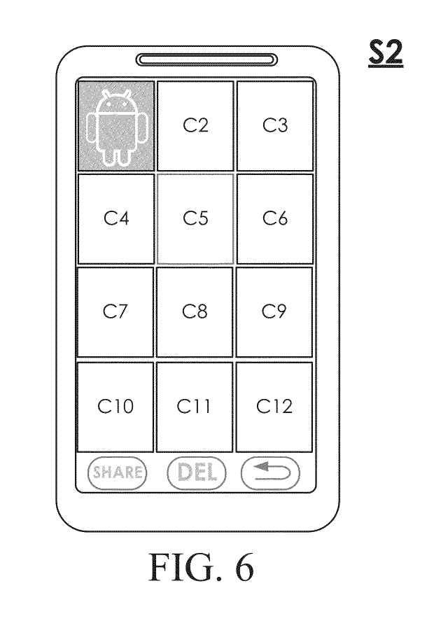

Please refer to FIG. 2B. FIG. 2B is a schematic diagram illustrating a second interface of the user interface according to an embodiment of the present invention. In the second interface S2, the first polyhedron icon 21 is unfolded in a counterclockwise direction, and formed the development drawings as shown in FIG. 2B. Therefore, users can click the display surface of the development drawings for switching into the third interface S3 directly, or return into the first interface S1 in accordance with the order of the user. Take for example the display surface with a photo, the first polyhedron icon 21 is unfolded with an animation effect, and the display surface of the development drawings can be presented in order of the numbers: C6, C5, C4, C3, and C2. Additionally, the users can turn off the animation effect in order to economize power and time. Please refer to FIG. 6, FIG. 6 is a schematic diagram illustrating a second interface of the user interface according to another embodiment of the present invention. In the invention, each display surface of the first interface S1 can be display into the second interface S2 with a flat matrix display.

Please refer to FIG. 2C, FIG. 2C is a schematic diagram illustrating a third interface of the user interface according to an embodiment of the present invention. In the third interface S3, users can browse, edit or execute the contents and the programs on the designated display surface. More particularly, as the presentation on the display surface is a photo, the photo can be displayed onto the third interface S3 with full-width. As the presentation is a video, the video can be played onto the third interface S3. As the presentation is an article or a web page, the third interface S3 can display corresponding image respectively. And as the presentation is a subprogram, the subprogram can be turned on and displayed onto the third interface S3.

As shown in FIG. 2C, users can use the function of the third interface S3 to edit the preview images. With the frame 24, a partial image of the photo, video, character, and symbol would be captured to be a preview image, so that the preview image can be used into the first interface S1 and the second interface S2, and the users can adjust the size, shape, and position of the frame 24 at will. Otherwise, the control module 14 is applied to capture a partial image automatically without the orders of the user. Furthermore, the first interface S1 can switch into the third interface S3 directly.

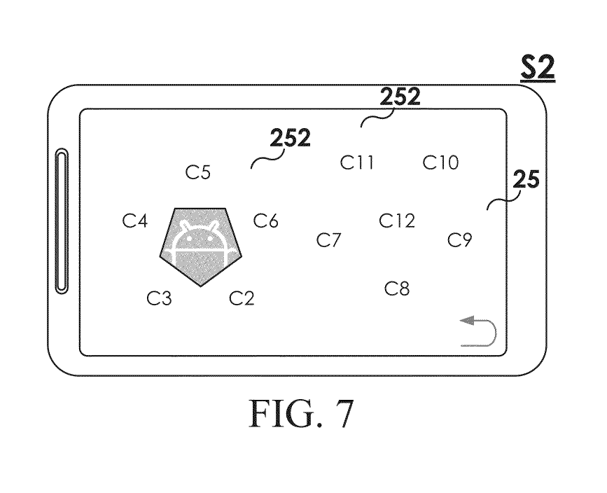

Additionally, the user interface of the electronic device further comprises an output mode. Please refer to FIG. 7. FIG. 7 is a schematic diagram illustrating an output mode of the user interface according to another embodiment of the present invention. As shown in FIG. 7, the user interface comprises a development drawing 25 of a second or third polyhedron icon 22, 23 when the user interface is in the output mode. Wherein, the development drawing 25 has a plurality of display surfaces which are applied to present a corresponding image respectively, and the periphery of the development drawing having a plurality of reserved intervals 252. Furthermore, the development drawing 25 can be turned into a three-dimensional polyhedron icon by adhering and folding the reserved intervals after printed.

To sum up, the present invention discloses a unique user interface of an electronic device. The present invention uses many original images to form a plurality of polyhedron icons. Moreover, the user interface comprises a first interface S1 and a second interface S2. The said first interface S1 has a displaying mode and an operating mode. The displaying mode is capable of automatically and continuously displaying a first polyhedron icon 21 by rotating thereto in a certain sequence. The operating mode is capable of rotating the polyhedron icon in accordance with the order of the user. The second interface S2 is capable of displaying the polyhedron by unfolding it so as to display the displaying surfaces thereof. Furthermore, the present invention has an output mode. In the output mode, a plurality of reserved intervals are added on the periphery of the development drawing of polyhedron icon so as to provide a non-digital, physical 3D polyhedron by cutting, adhering and folding the reserved intervals. Additionally, the invention provides a switching speed of the display surfaces which is one to three times faster than conventional ones, and the invention also comprises a function of correcting the image orientation. Therefore, the present invention can improve the problems of the prior art.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A user interface of an electronic device, comprising:
a first interface, comprising:
a first region with a first polyhedron icon; and
a second region with a second polyhedron icon and a plurality of third polyhedron icon;
wherein each of the first, second and third polyhedron icons has N display surfaces and each of the display surfaces presents a respective image, wherein N is a natural number greater than two.

2. The user interface of claim 1, wherein the images of the display surfaces on the first polyhedron icon and the images of the display surfaces on the second polyhedron icon are the same.

3. The user interface of claim 2, wherein the images of the display surfaces on the first polyhedron icon and the images of the display surfaces on the third polyhedron icon are all different.

4. The user interface of claim 1, wherein the images of each display surface on the first polyhedron icon and the images of each display surface on the polyhedron icons configured on the second region are all different.

5. The user interface of claim 1, wherein the second polyhedron icon is configured on the perpendicular bisector of the first interface, and the area occupied by the second polyhedron icon is greater than the area occupied by the third polyhedron icon.

6. The user interface of claim 1, wherein the area occupied by the first polyhedron icon is greater than the area occupied by the second polyhedron icon.

7. The user interface of claim 1, wherein the first region is adjacent to the second region without any overlap.

8. The user interface of claim 1, wherein the polyhedron icons on the second region are adjacent to each other without any overlap.

9. The user interface of claim 1, wherein the sizes and the positions of the first polyhedron icon, the second polyhedron icon, and the third polyhedron icon can be adjusted according to the settings of a user.

10. The user interface of claim 1, wherein the first interface further comprises a fourth region for displaying a working envelope, and the content of the working envelope corresponds to the content of the display surface which has the largest area on the first polyhedron icon, wherein the fourth region is adjacent to the first region and the second region without any overlap.

11. The user interface of claim 1, further comprising:
an output mode for displaying a development drawing of the first polyhedron icon, the first polyhedron icon having a plurality of display surfaces for presenting a corresponding image respectively, and the periphery of the development drawing having a plurality of reserved intervals.

12. The user interface of claim 11, wherein the development drawing can be turned into a three-dimensional polyhedron icon by adhering and folding the reserved intervals after printed.
